(19) United States
(12) Patent Application Publication
(10) Pub. No.: US 2024/0368050 A1
(43) Pub. Date: Nov. 7, 2024

(54) ENHANCED PERFORMANCE UREASE INHIBITOR, COMPOSITIONS AND METHODS THEREOF

(71) Applicant: NANOCHEM SOLUTIONS, INC., Peru, IL (US)

(72) Inventors: Alexander Polozov, Peru, IL (US); Joseph Fan, Peru, IL (US); George Murray, Peru, IL (US); Daniel O'Brien, Peru, IL (US)

(73) Assignee: NANOCHEM SOLUTIONS, INC., Peru, IL (US)

(21) Appl. No.: 18/652,666

(22) Filed: May 1, 2024

Related U.S. Application Data
(60) Provisional application No. 63/499,261, filed on May 1, 2023.

(51) Int. Cl. C05G 3/90; C05C 9/00

(52) U.S. Cl. CPC C05G 3/90; C05C 9/00

(57) ABSTRACT

A fertilizer composition comprising a urea component, a NBPT component, and a oxidizer component. The urease inhibitor fertilizer compositions and methods can include N-(n-Butyl)thiophosphoric triamide (“NBPT”) or oxidized N-(n-Butyl)thiophosphoric triamide (“NBPTO”) and oxidizers for soil treatment can be applied directly to soil or onto urea.

### CROSS-REFERENCE TO RELATED APPLICATIONS

The U.S. patent application claims priority to U.S. Provisional Patent Application No. 63/499,261 filed May 1, 2023, to the above-named inventors of which the disclosure is considered part of the disclosure of this application and is herein incorporated by reference in its entirety.

### FIELD OF THE INVENTION

The invention relates generally to urease inhibitors, compositions and methods thereof. More particularly, the invention relates to urease inhibitor compositions and methods involving the addition of N-(n-Butyl)thiophosphoric triamide (“NBPT”) or oxidized N-(n-Butyl)thiophosphoric triamide (“NBPTO”) and oxidizers for soil treatment.

### BACKGROUND

Urea contains almost 47% of nitrogen and it has become the most important nitrogen fertilizer commonly used in agriculture. The efficiency of this fertilizer in soil is greatly reduced due to hydrolysis by the urease enzyme, that is produced by soil naturally occurring bacteria and fungi. Urease (urea amidohydrolase; EC 3.5.1.5) catalyzes the hydrolysis of urea to yield ammonia and carbamate. The latter compound spontaneously decomposes to yield another molecule of ammonia and carbonic acid (H. L. Mobley et al., Microbiol. Rev., 451-480, 1995).

The lifespan of urea in soil might be extended by application of nitrification inhibitors and urease inhibitors. The application of nitrification inhibitors and urease inhibitors is extensively developed and optimized at large industrial scale and preferably applied on molten urea as a nitrogen stabilizer composition to form a granular urea-inhibitor composition, which maintains improved stability compared with solutions of nitrification inhibitors, such as NBPT those found in U.S. Pat. App. No. US20180016200A1.

The longevity of urea protection by ^{˜}0.1% NBPT is around one week according to the literature and to our own studies. Urea can only benefit plants as an aqueous solution, so the protecting urease inhibitor NBPT must be also dissolved and spread along with urea.

There are some known methods of improvements for enhanced urease inhibition, such as improved delivery formulations, mostly in DMSO and PG and other glycols as a mixture of protic and aprotic solvents (U.S. Pat. No. 11,312,667 B2) and NBPT adduct formation with formaldehyde (see e.g., U.S. Pat. App. No. 20220177384A1). However, these modifications do not achieve significant NBPT enhancing and do not extend the longevity of urease inhibition.

It is known that NBPT is a precursor of an active-oxidized form/oxygen-analog called NBPTO. NBPT is not active itself and it needs time to be oxidized in soil to render the active compound NBPTO. During the conversion from NBPT to NBPTO, there is an obvious possibility that at least part of NBPT is lost to the decomposition in a competitive process (Hendrickson et al, Soil Biol. Biochem. 25, 1613, 1993).

The idea of increasing the rate of oxidation of NBPT was confirmed in oxidized flooded rice soil (purged with air), that ended up with significant retarding of urea in oxidized soil compared with reduced soil (purged with Ar gas)(Lindau et al, Communications in Soil Science and Plant Analysis, 775-788, 1989). Unfortunately, these experiments could not be explained in terms of NBPT oxidation since oxygen is not able to oxidize thiophosphoryl group (P═S) without metallic catalysts. Also, the effectiveness of NBPT in similar soils was demonstrated using an oxidized technique by oxygen or hydrogen peroxide Qui-Xiang et al, Soil Biol. Biochem, 1059-1065, 1994).

Again, use of oxygen which is unable to catalyze the oxidization of NBPT made these results doubtful. When the range of oxidizers were narrowed to only two (2) examples and application conditions were limited, it was unexpected that the phenomenon of enhancing NBPT's urease-inhibition effect and increasing of longevity of urea protection would be common and the oxidizers would be efficient for the whole range of application methods.

Many oxidizers may be useful for oxidation of thiophosphates. Most common are peroxides, peroxiacids, potassium peroxymonosulfate, dinitrogen tetraoxide and ozone. And, also, oxidation of thiophosphates can be carried out by enzymes (Lazarevic-Pasti, Biochem. Physiol. 100, 140-144, 2011). However, none of them except hydrogen peroxide were applied before in soil conditions along with NBPT.

Therefore, there exists a need for an improved composition to enhanced urease inhibition to increase the longevity of urea protection.

### BRIEF SUMMARY OF THE INVENTION

In one aspect, the present disclosure relates to a fertilizer composition comprising a urea component, an NBPT component, and an oxidizer component. In one aspect, the invention can generally be described as a composition for enhanced performance urease inhibition for increasing urease stability and performance in soil. Further, the invention can generally be described as a composition and methods comprising the addition of an NBPT component. An NBPT component can include but is not limited to NBPT, or NBPTO, or one of NBPT/NBPTO and one or more oxidizers for soil treatment. In some exemplary embodiments, the NBPT component and oxidant can be combined together prior to application to soil or as a coating. Alternatively, the components can be separately applied.

In yet another aspect, the present disclosure relates to a method of enhancing urease inhibitor performance and treatments of soil for improved performance. A soil treatment can include the application of a urea component, a NBPT component, and an oxidizer component. The oxidizer component can improve the urease inhibition resulting in a delayed urease-catalyzed transformation of urea to ammonium to allow for greater absorption time or dissipation of nitrogen (N) forms into the soil.

In another aspect, the present disclosure is related to a fertilizer composition. The fertilizer composition can include a urea component, a NBPT component, and an oxidizer component. In some exemplary embodiments, the NBPT component and oxidizer component can be applied to the urea component. In other exemplary embodiments, the NBPT component and oxidizer component can be combined to form a NBPTO component and coated onto the urea component. In other exemplary embodiments, the NBPT component and/or the oxidizer component can be dissolved into a solvent prior to application on the urea component.

In another exemplary embodiment, the present disclosure relates to a method for treating soil to enhance the performance of a urease inhibitor. A urea component can first be applied to a soil. The NBPT component can then be applied to the soil. An oxidizer component can then be applied to the soil. In some exemplary embodiments, the NBPT component and oxidizer component can be combined prior to application to the soil. In another exemplary embodiments, a NBPTO component

In another exemplary embodiment, the present disclosure relates to a method of treating soil with urea to extend the longevity or urease inhibition. The method can include providing a urea component to the soil. A NBPT component can then be provided to the soil. An oxidizer component can be provided and configured to oxidize the NBPT component and further enhance the performance of the NBPT component.

In another aspect, the present disclosure is related to a method to generate a NBPTO composition for application to soil or fertilizer material, including but not limited to urea. The NBPTO composition can be applied directly to urea treated soil or alternatively as a coating to urea prior to being applied to soil.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a ³¹P NMR (60 MHz) of an exemplary embodiment of an NBPTO composition of the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

In one exemplary embodiment, the fertilizer or soil amendment composition of the present disclosure can include a mixture of one or more components or portions. A urea component, a NBPT component, and an oxidizer component can be applied to a soil surface in any suitable order. A fertilizer composition of the present disclosure can be comprised of a urea component, an NBPT component, and oxidizer component, and a solvent component. In some exemplary embodiments, the NBPT and oxidizer component can be combined together with a solvent component to form a homogenous coating that can be applied to a urea component. The homogenous coating or mixture can comprise between 0.25-1.0% of total weight of the fertilizer composition and the urea component can comprise between 99.0-99.75% of the total weight of the fertilizer composition.

In some exemplary embodiments, the oxidizer component or oxidant that can be provided as part of the composition can enhance NBPT performance. While not intending to be bound by this list, a oxidizer component or oxidant can be selected from at least one or more of the following: sodium perborate tetrahydrate, Sodium Percarbonate, Sodium Persulfate, Sodium Peroxomonosulfate, Potassium Perborate tetrahydrate, Potassium Percarbonate, Potassium Persulfate, Potassium Peroxomonosulfate, Lithium Perborate tetrahydrate, Lithium Percarbonate, Lithium Persulfate, Ammonium Perborate tetrahydrate, Ammonium Percarbonate, Ammonium Persulfate, Hydrogen Peroxide 3-60% solution in water, Urea Hydrogen Peroxide, Peroxiacids, for example, 3-Chloroperoxybenzoic acid, Peracetic Acid, Trifluoroacetic Peracid, Phthaloyl Peroxide, and others, Oxiranes, for example Dimethyldioxiran; Potassium Permanganate, Ozone, Alkyl Hydroperoxides, Aryl Hydroperoxides, Heterocyclic Hydroperoxides, Chromium Trioxide, Jones Reagent, Iodine Pentoxide, Iron Trichloride, Manganese (IV) Oxide, Nitric Acid, Osmium Trioxide, Periodic Acid, Peroxides, for example Benzoyl Peroxide, Dicumyl Peroxide, Cumene Hydroperoxide, tert-Butyl Hydroperoxide, Phthaloyl Peroxide, Bis(Methanesulfonyl) Peroxide, Bis(Trimethylsilyl) Peroxide, Pyridine N-Oxide, Sodium Hypochrorite, Sodium Periodate, DMSO, N-bromosuccinimide, Bromine, Nitrogen Tetroxide, Nitric acid, Trifluoroacetic Anhydride, Oxaziridines, Nitroxyl Radicals, Perhydrates, Enzymes, for example, Chloroperoxidase, Lignin Peroxidase, Horseradish Peroxidase, Cytochrome C, Myeloperoxidase and other suitable oxidizers. The oxidizer component can comprise between 0.025-0.1% by weight of the total weight of the fertilizer composition.

Additionally, inhibitors of oxidation and activators of oxidation could be added to the components in several ways. Oxidation could be inhibited at one stage of application to urea, then activated by a second liquid or solvent during the second stage. Bases, radical initiators and acids could serve as activators of oxidation. Radical scavengers, hydroquinones, phenols, mercaptans, diamines, ascorbic acid, glutathione can serve as inhibitors of oxidation.

Any suitable solvent or a suitable mixture of solvents in any proportions may be used for application with NBPT, except for solvents that easily oxidized such as aliphatic aldehydes. While not intending to be bound by this list, a solvent component or mixture of solvents can be selected from at least one or more of the following: alcohol series solvents, polar aprotic series solvents, aromatic hydrocarbon series solvents, ethers and ester series solvents, water, ketones, ethylene glycol and derivatives, and ethanolamines amount others.

Alcohol series solvents can include but are not limited to methyl alcohol, ethanol, n-propyl alcohol, iso-propyl alcohol, n-butanol, iso-butanol, sec-butyl alcohol, the tert-butyl alcohol and glycerol. Polar aprotic series solvents can include but are not limited to dimethylformamide, Dimethylacetamide, N-methyl pyrrolidone, DMSO, sulfolanes, dialkyl sulfoxide, diaryl sulfoxide, alkylaryl sulfoxide. Aromatic hydrocarbon series solvents can include but are not limited to toluene, xylenes. Ethers and esters series solvents such as ether, tetrahydrofuran, dioxanes, ethyl acetate, methyl acetate, propyl acetates, butyl acetates, methyl propionate, ethyl propionate, butyls propionates. Ketones solvents such as acetone, di-iso-butylketone, propylene carbonate. Ethylene glycol and derivatives solvents can include but are not limited to propylene glycol, butylene glycol, ethylene glycol monobutyl ether, glycol ethers, glycol esters. Ethanolamines solvents can include but are not limited to ethanolamine, diethanolamine, triethanolamine, N-methyl diethanolamine, 2-(2(2-hydroxyethoxy) ethyl)(methyl)amino)ethanol. In some exemplary embodiments, a solvent component can comprise between 0-0.15% by weight of the total weight of the fertilizer composition.

NBPT oxidation composition system and methods can further include and be used with dicyandiamide (“DCD”) and other nutrification agents.

NBPT or NBPTO and oxidizer may be added in any order as described below. Similarly, the addition of urea, NBPT and oxidant could be different depending upon the desired application and previous treatments provided to a soil. In some exemplary embodiments, the NBPTO component can be a composition formed to be applied to a urea component or a soil environment. In one exemplary embodiment, an NBPT or NBPTO component can be combined with oxidant component preferably in solvent to form a coating slurry or mixture. The coating mixture can then be applied over urea, which can then be applied over a soil or added to a soil.

Alternatively, NBPT component could be combined with an oxidant component preferably in solvent to form a treatment mixture. The treatment mixture can then be applied over soil at a prescribed rate. In some exemplary embodiments, a treatment mixture can comprise between about 0.25-1% of the total weight of the total treatment including a urea component. A urea component can then be provided or added to the soil at a ratio of between about 9:1 urea to NBPTO ration to about a 9.9:0.1 urea to NBPTO ratio. In another exemplary embodiment, a ration between 99:1 and 99.75:1 urea to NBPTO mixture ratio.

Alternatively, various combinations of the Urea and treatment mixture can be provided on a soil in various order in order to obtain similar results. Urea could be applied over soil, then a treatment mixture can be applied to the soil and previously applied urea.

In other exemplary embodiments, a urea component can be applied over soil. An NBPT component can be mixed with a solvent at a ratio between about 1:3 and 3:1 and applied to the soil and previously applied urea component. An oxidizer component can additionally be mixed with a solvent in a ration of between about 1:3 and 3:1. The oxidizer and solvent solution can then be applied to the soil. Alternatively, the oxidizer and solvent solution can be applied before the NBPT solution. NBPT component could be combined with urea and an oxidant can then be added to the urea and NBPT. The final composition can then be added to the soil.

Other methods of application and combinations of exemplary embodiments can include the following. An oxidant could be combined with urea, then NBPT component can added, then applied over soil. NBPT or NBPTO could be applied over soil, preferably in solvent, then following of combination of urea and oxidant. NBPT component could be applied over soil, preferably in solvent, followed by urea, then followed by oxidant preferably in solvent. NBPT component could be applied over soil, preferably in solvent, followed by oxidant preferably in solvent, then followed by urea. Oxidant could be applied over soil, preferably in solvent, then following of combination of urea and NBPT component. Oxidant could be applied over soil, preferably in solvent, followed by urea, then followed by NBPT component, preferably in solvent. Oxidant could be applied over soil, preferably in solvent, followed by NBPT component, preferably in solvent, then followed by urea. All other possible ways of addition urea, NBPT and oxidant over soil.

There are several possible combinations of urease inhibitor, solvent and oxidizer. The following provides a number of exemplary embodiments of a composition of the present disclosure based on NBPTO and other examples, which are not intended to be limiting.

In order to prove that NBPT could be oxidized quantitatively, we converted NBPT by using urea hydrogen peroxide (UHP) and tested for comparison with NBPT. It showed up to eight-fold urease inhibition increase. In one exemplary embodiment, an NBPTO component can be derived. A NBPT component can be added at about between 500-800 g to a flask with a solvent between about 800-1300 g. The mixture can be headed and stirred until the NBPT component is dissolved. A urea component can be added to the mixture at an amount of between about 350-1000 g and heated and then cooled. The product can then have a sulfur component removed and filter a resulting crude NBPTO product by washing the NBPTO product through a filter with a solvent. In some exemplary embodiments, the ratio of NBPT to Urea can be between about 3:1 or about 1:3, or alternatively in an about 1:1 mixture.

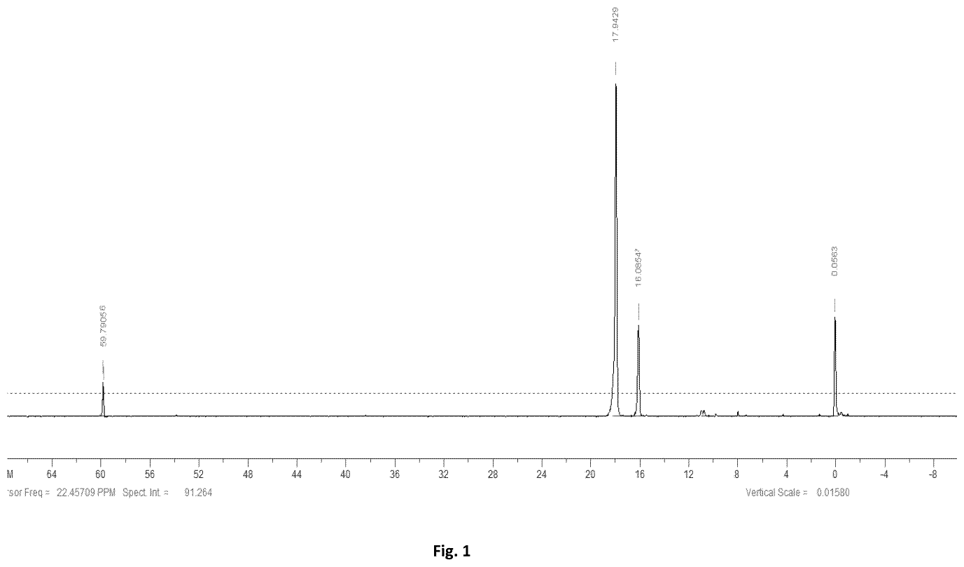

In one exemplary embodiment, about 600 g of NBPT with a purity between about 70% and 100% can be added into a flask. About 1114 g of ethylene glycol (“EG”) can then be added to the flask and the NBPT component. The mixture can be slightly headed and stirred until all the NBPT component was dissolved in the EG solvent component. About 506.3 g of a urea component can be added in portions at between about 45-50° C. In one exemplary embodiment, the urea component can be urea hydrogen peroxide. The mixture can be cooled for about 3 hours. The reaction mixture can then be stirred at about 45° C. for about 60 minutes and then reaction mixture can be heated by heating mantel to about 60° C. in 30 min. The reaction mixture can then be allowed to cool to about 52° C. in 20 min and then cooled to room temperature to afford about 2.22 kg of reaction mixture. Part of the product (250 g) containing sulfur was taken away (total RM 2.22 kg). The rest of the product can be filtered on paper and washed with EG (20 g×3) to afford a crude NBPTO (2047.6 g) as orange clear solution. See in FIG. 1 the 31P NMR (60 Mhz) proved conversion of NBPT (59.7 ppm) to NBPTO (17.94 ppm). Sulfur was carefully collected and dried on aluminum pan for 6 h at 120-130° C. (to melt) to afford 78.43 g (72.4% yield).

For the purpose of oxidants performance evaluation, we used urease inhibitor testing method, created to evaluate the inhibition ability of treatment to reduce the amount of ammonia formed described below, that allowed accurate comparable between NBPT/urea and Oxidant/NBPT/urea samples. The composition of and methods of the present disclosure can be monitored and tested. A treatment amount can be first weighted out to a desired amount. In one exemplary embodiment, about 16 mg of treatment was weighted out. An amount of urea can then be weighted out. In one exemplary embodiment, about 5.0 g urea was weighted out. A prescribed amount of solvent can be weighted and added to the treatment composition and the urea to dissolve the urea. In some exemplary embodiments, the solvent can be water. About 10 mL of water can be added to 16 g of treatment and the about 5 g of urea. The final mixture composition can then be applied to the top surface of a prescribed amount of soil, such as 60 g of soil and sealed. After between about 3 days to 1 week, pen the lid and ammonia can be tested with Draeger tube. The test can be prolonged to more than 3 days. The tables below provide the results of testing utilizing the above testing method.

TABLE 1
Urease Inhibitor Test (ammonia ppm).

| | Sol- | Concentra- | Sample, | 3 | 1 | 2 | 3 |
|---|---|---|---|---|---|---|---|
| Material | vent | tion, % | mg | days | week | weeks | weeks |
| NBPT | PG | 26.7% | 17 | 13 | 35 | 600 | n/a |
| NBPTO | EG | 24.0% | 19 | 0.05 | 0.6 | 1 | 5 |

TABLE 2
Urease Inhibitor Test with additional oxidant components (ammonia ppm).

| Material | Solvent | Concentration, % | Sample, mg | 3 days | 1 week |
|---|---|---|---|---|---|
| NBPT | PG | 26.70% | 8 | 5 | 800 |
| Potassium Persulfate | n/a | neat | 4 mg per 8 mg of NBPT | 1 | 140 |
| Hydrogen Peroxide, 10% | water | 10% | 17 mg per 16 mg of NBPT | 0.1 | 400 |
| Potassium Permanganate | n/a | neat | 4 mg per 8 mg of NBPT | 2 | 50 |

In one exemplary embodiment, a composition of the present disclosure can be comprised of a NBPT component and an oxidizer component to form a coating mixture. The coating mixture can be applied to the urea component to fully coat the urea component.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A fertilizer composition comprising:
a urea component;
a N-(n-Butyl)thiophosphoric triamide (“NBPT”) component; and
an oxidizer component.

2. The composition of claim 1, wherein the urea component comprises between 99.0-99.75% by weight of the total weight of the fertilizer composition.

3. The composition of claim 2, wherein the NBPT component comprises between 0.025-0.15%% by weight of the total weight of the fertilizer composition.

4. The composition of claim 3, wherein the oxidizer component comprises between 0.025-0.1%% by weight of the total weight of the fertilizer composition.

5. The composition of claim 4, wherein the fertilizer composition further includes a solvent component.

6. The composition of claim 4, wherein the solvent component comprises between 0.0001-0.15% by weight of the total weight of the fertilizer composition.

7. The composition of claim 5, wherein the oxidizer component is selected from at least one of the following:
Sodium Perborate tetrahydrate, Sodium Percarbonate, Sodium Persulfate, Sodium Peroxomonosulfate, Potassium Perborate tetrahydrate, Potassium Percarbonate, Potassium Persulfate, Potassium Peroxomonosulfate, Lithium Perborate tetrahydrate, Lithium Percarbonate, Lithium Persulfate, Ammonium Perborate tetrahydrate, Ammonium Percarbonate, Ammonium Persulfate, Hydrogen Peroxide 3-60% solution in water, Urea Hydrogen Peroxide, Peroxiacids, for example, 3-Chloroperoxybenzoic acid, Peracetic Acid, Trifluoroacetic Peracid, Phthaloyl Peroxide, and others, Oxiranes, for example Dimethyldioxiran; Potassium Permanganate, Ozone, Alkyl Hydroperoxides, Aryl Hydroperoxides, Heterocyclic Hydroperoxides, Chromium Trioxide, Jones Reagent, Iodine Pentoxide, Iron Trichloride, Manganese (IV) Oxide, Nitric Acid, Osmium Trioxide, Periodic Acid, Peroxides, for example Benzoyl Peroxide, Dicumyl Peroxide, Cumene Hydroperoxide, tert-Butyl Hydroperoxide, Phthaloyl Peroxide, Bis(Methanesulfonyl) Peroxide, Bis(Trimethylsilyl) Peroxide, Pyridine N-Oxide, Sodium Hypochrorite, Sodium Periodate, DMSO, N-bromosuccinimide, Bromine, Nitrogen Tetroxide, Nitric acid, Trifluoroacetic Anhydride, Oxaziridines, Nitroxyl Radicals, Perhydrates, Enzymes, for example, Chloroperoxidase, Lignin Peroxidase, Horseradish Peroxidase, Cytochrome C, or Myeloperoxidase.

8. The composition of claim 6, wherein the solvent portion is selected from at least one of the following:
methyl alcohol, ethanol, n-propyl alcohol, iso-propyl alcohol, n-butanol, iso-butanol, sec-butyl alcohol, the tert-butyl alcohol and glycerol, dimethylformamide, Dimethylacetamide, N-methyl pyrrolidone, DMSO, sulfolanes, dialkyl sulfoxide, diaryl sulfoxide, alkylaryl sulfoxide, toluene, xylenes; ether, tetrahydrofuran, dioxanes, ethyl acetate, methyl acetate, propyl acetates, butyl acetates, methyl propionate, ethyl propionate, butyls propionates; Water; Ketones such as acetone, di-iso-butylketone, propylene carbonate; Ethylene glycol and derivatives, such as propylene glycol, butylene glycol, ethylene glycol monobutyl ether, glycol ethers, glycol esters; Ethanolamines such as Ethanolamine, diethanolamine, triethanolamine, N-methyl diethanolamine, 2-((2(2-hydroxyethoxy) ethyl)(methyl)amino)ethanol.

9. The composition of claim 8, wherein the NBPT component is a synthesized NBPTO component.

10. The composition of claim 9, further comprising dicyandiamide (“DCD”).

11. A method of treating of treating soil to enhance the performance of a urease inhibitor:
provide a urea component to the soil;
provide a NBPT component to the soil; and
provide an oxidizer component to the soil.

12. The method of claim 11, wherein the NBPT component and oxidizer component are combined to form an NBPTO component prior to applying to the soil.

13. A method of treating a soil with urea to extend the longevity of urease inhibition comprising:
providing a urea component to the soil;
providing an NBPT component to the soil;
providing an oxidizer component configured to oxidize the NBPT component and further enhance the performance of the NBPT component.
